(19) United States
(12) Patent Application Publication
(10) Pub. No.: US 2025/0002295 A1
(43) Pub. Date: Jan. 2, 2025

(54) METHOD OF OPERATING AN ELEVATOR SYSTEM AND ELEVATOR SYSTEM

(71) Applicant: Inventio AG, Hergiswil (CH)

(72) Inventors: Valerio Villa, Colverde (IT); Teresa Zotti, Ebikon (CH)

(21) Appl. No.: 18/709,046

(22) PCT Filed: Nov. 16, 2022
(86) PCT No.: PCT/EP2022/082126

§ 371 Date: May 10, 2024

(30) Foreign Application Priority Data
Nov. 18, 2021 (EP) 21209024.5

(51) Int. Cl. B66B 1/34

(52) U.S. Cl. CPC B66B 1/3461; B66B 1/3453; B66B 1/3492

(57) ABSTRACT

A method operates an elevator system that includes an elevator car, a first communication device, and a plurality of stationary second communication devices communicatively connected to the first communication device. The method includes determining car position indicators, each of the car position indicators being indicative of a position and/or a position-dependent communication condition of the elevator car relative to an associated one of the second communication devices. The method further includes, based on the car position indicator, determining a priority indicator for each of the second communication devices and, based on the priority indicators, prioritizing or non-prioritizing a communication between the first communication device and each of the second communication devices.

### FIELD

The present invention relates to an elevator system, particularly an elevator system suitable for passenger transport, and a method of operating an elevator system. Components of the elevator system are configured for prioritizing or non-prioritizing a communication therebetween.

### BACKGROUND

Modern elevator systems often employ constant or near-constant communication between components of the elevator system. Such components can include user interfaces, such as car or landing operating panels, door controllers, control units such as a car control unit, sensors or the like. The components are typically connected in a network, such as a control network. Some components may be installed in the elevator car and thus be mobile, while other components may be stationary and installed e.g. at the landings. The network can be implemented as both a wire-based network, as well as a wireless network, or a combination thereof.

In a typical configuration, the components communicate over the network having a limited bandwidth. In some cases, if too many components transmit at the same time, data packets of the communication may interfere or collide, or may be only transmitted with a delay, potentially leading to an unreliable communication. In some cases, this may result in travel delays or service interruptions, for example if safety-relevant data, such as sensor data, or instruction signals such as a door open signal cannot be transmitted reliably.

While some of the above-mentioned problems may be mitigated by increasing the overall bandwidth of the network and/or providing additional access points, signal repeaters, redundant communication lines or the like, this typically increases the complexity of the elevator system, the cost of planning and setup, and may introduce further components that may require additional maintenance.

### SUMMARY

Thus, there is a need for an improved elevator system or method of operating an elevator system having communication devices. Such needs may be met with the subject-matter of the advantageous embodiments defined in the specification that follows.

According to an aspect, a method of operating an elevator system is provided. The elevator system includes an elevator car, a first communication device, and a plurality of stationary second communication devices communicatively connected to the first communication device. The method includes determining a car position indicator, the car position indicator being indicative of a position and/or a position-dependent communication condition of the elevator car relative to at least one of a plurality of second communication devices. The method includes, based on the car position indicator, determining a priority indicator for each of the plurality of second communication devices. The method further includes, based on the priority indicator, prioritizing or non-prioritizing a communication between the first communication device and the at least one of the plurality of second communication devices.

According to an aspect, an elevator system is described. The elevator system includes an elevator car, a first communication device, and a plurality of stationary second communication devices communicatively connected to the first communication device. The first communication device is configured for determining, based on the elevator car position and/or a position-dependent communication condition, a car position indicator, the car position indicator being indicative of a position of the elevator car relative to at least one of the plurality of second communication devices. The first communication device is configured for determining, based on the car position indicator, a priority indicator for each of the plurality of second communication devices. The first communication device is configured for, based on the priority indicator, prioritizing or non-prioritizing the communication between the first communication device and the at least one of the plurality of second communication devices.

According to an aspect, a use of a first communication device and at least one of a plurality of second communication devices in an elevator system according to embodiments is described.

According to an aspect, a computer program and a computer-readable medium having stored thereon the computer program is described. The computer program includes instructions to cause a communication device in an elevator system to execute the operation of a method according to embodiments described herein.

In an elevator system having multiple landings and landing door control units, which could act as second communication devices, provided at each landing, as well as a car control unit, which could act as or communicate with a first communication device, provided within or on the elevator car, a constant transmission of safety relevant data from the door control units to the car control unit is generally desirable. The safety relevant data can include, for example, information about a door status (locked, unlocked, closed, partially open, fully open, etc.). In a conventional elevator system according to an example, the safety relevant data is continuously provided to the car control unit at predefined intervals and evaluated by the car control unit to constantly monitor the status of the elevator system. However, the bandwidth for transmitting this safety relevant data is limited. In cases where the limited bandwidth results in packet collisions and increased transmission latency due to concurrent transmitting of safety relevant data by the door control units, a reliable, low-delay communication is not possible. Thus, in order to decrease potential packet collisions, an improved method for communicating such safety relevant data is desired. According to the aspects and embodiments described herein, a prioritization of certain communications according to a priority indicator between a second communication device and the first communication device can solve or at least reduce the described problem.

According to an aspect, a first communication device is described. The first communication device can move with the elevator car, and/or can be coupled to the elevator car. The first communication device may also be provided away from the elevator car, such as e.g. in a machine room of the elevator system. The first communication device may be a control unit, such as a car control unit (CCU), which is a controller of the elevator system. The first communication device or the control unit respectively can control functions of the elevator system. The control unit can be communicatively connected, particularly via a wired or wireless connection, with a plurality of second communication devices, such as sensors and/or input devices, such as door sensors or landing operating panels, to receive input signals. The control unit can be communicatively connected with other controllers, such as door controllers for controlling the opening or closing of the elevator car door or the landing door, a power node for controlling the elevator drive system, or the like. The control unit can, e.g. based on user inputs received e.g. via the landing operating panels or a cabin operating panel, calculate a route of the elevator car and operate the elevator system to move the elevator car within the elevator shaft according to the calculated route. The control unit may include further or alternative functions than those described above. While the first communication device may be a control unit or be included in a control unit, the first communication device may also include or be included in other such devices, such as an access point of a wireless network, a wireless repeater, a car operating panel, or the like.

According to an aspect, the elevator system includes a plurality of second communication devices. The second communication devices are stationary, particularly stationary with respect to the elevator car and/or the first communication device. The second communication devices may be, for example, door control units, landing operating panels, sensors or the like, be included in such devices, or be communicatively connected to such devices. The second communication devices may be single units, or an assembly of units, for example, a second communication device may include a sensor, such as a landing door sensor, and a door control unit, e.g. for controlling the opening and closing of a landing door. The second communication devices may be, fully or in part, included in components configured for limited movement, e.g. a sensor may be attached to a landing door, and the movement of the landing door may cause a movement of the sensor. In the context of this disclosure, such limited movement shall be understood as stationary, particularly with respect to the elevator car.

According to an aspect, a second communication device of the plurality of second wireless communication devices may be installed on a plurality of landings of the elevator system, such as on most or all landings of the elevator system. In one example, an elevator system having n landings may include n, n−1, n−2, n−3, . . . second communication devices. A second communication device is not limited to being installed on a landing, for example, a second communication device may also be provided in the vicinity of the landing, in a landing door, inside an elevator shaft, or the like, and multiple second communication devices may be provided at one location or landing.

According to an aspect, the first communication device and at least one of the plurality of second communication devices are configured for bidirectional communication therebetween. Bidirectional communication between the first communication device and the plurality of second communication devices may be provided by communicatively connecting the first communication device and the plurality of second communication device in a packet-based communication network. The packet-based communication network may include a packet-based telecommunication network. The packet-based communication network may be a local area network or even a wide area network. The packet-based communication network may be configured for transmitting data between nodes of the packet-based communication network, and the first communication device and the plurality of second communication devices may be nodes within the packet-based communication network. The packet-based communication network can be an ethernet network, a wireless (Wi-Fi) network, or another known packet-based communication network. For example, network technologies such as 2G, 3G, LTE, 5G or the like may be employed additionally or alternatively. The packet-based communication network may include sub-networks comprised of different network types, i.e. some of the first communication device and the plurality of second communication devices may be communicatively connected in an ethernet network, and some of the first communication device and the plurality of second communication devices may be communicatively connected in a wireless network, the ethernet network and the wireless network preferably being communicatively connected.

The bidirectional communication may be provided within a wireless communication network, such as a network according to the IEEE 802.11 WLAN standards. The bidirectional communication may be provided within a wire-based communication network, such as an ethernet network according to the IEEE 802.3 standard. The bidirectional communication may include the sending/transmitting and receiving of data packets. The first communication device may include, or be configured as, an access point of a wireless network and communicate directly with the plurality of second communication devices. Bidirectional communication may include sending a data packet by a second communication device, receiving the data packet by the first communication device, and sending a response data packet acknowledging the receipt of the data packet. Bidirectional communication may further include sending a data packet by the first communication device, the data packet e.g. including a request or an instruction, and, by the second communication device, sending a response data packet, including, for example, a response to the instruction or request.

According to an aspect, a car position indicator indicative of a position and/or a position-dependent communication condition of the elevator car relative to at least one of a plurality of second communication devices is determined, and/or the first communication device or the at least one of the plurality of second communication devices is configured for determining a car position indicator indicative of a position and/or a position-dependent communication condition of the elevator car relative to at least one of a plurality of second communication devices. The car position indicator may indicate the physical distance and/or the perceived physical distance between the first communication device and a second communication device, or some or all of the plurality of second communication devices. The perceived (physical) distance may be an approximation of the physical distance between the first communication device and the second communication device. A position-dependent communication condition may be a condition in which a prioritized communication between the first communication device and a specific second communication device, or a selection of the plurality of second communication devices, may be desirable or even essential. An example for a position-dependent communication condition may be a car being adjacent to a landing, an elevator controller including the first communication device, and a landing door controller of the landing including the second communication device. A prioritization of the communication between the elevator controller and the landing door controller may be desirable for reliably performing a synchronized door opening and closing of the elevator car doors and the landing doors. Thus, the car position indicator indicating the elevator car being adjacent to a landing is indicative of the position-dependent communication condition indicating that a communication between the elevator controller and the landing door controller should be prioritized. Other examples for position-dependent communication conditions are explained in further detail with respect to aspects and/or embodiments described herein.

According to an aspect, determining the car position indicator may include known methods for determining an elevator car position. The car position indicator may be determined from an elevator car position. The elevator car position may be determined by reading a physical position indicator, e.g. with a car position determining module provided on the elevator car. Other known methods for determining the elevator car position may be utilized. The car position indicator may be determined by receiving an elevator car position from a control module configured for controlling a movement of the elevator car and/or determining an elevator car position. The received elevator car position may be converted to result in the car position indicator.

According to an aspect, the elevator system may include a device map. The device map may be stored in a memory configured to be accessed by a controller. The memory and/or the controller may be included in the first communication device. The controller may be a controller communicatively connected to the first communication device and/or the at least one of the plurality of second communication devices. The first communication device may include the controller. The device map may include the positions of all or at least some of the plurality of second communication devices. The device map may include, for each mapped device, a device identifier, such as a device ID, such as a MAC address or an IP address of the device. In a first example, the device map may be represented as a table comprising, for each landing, a list of second communication devices located at the landing. In a second example, the device map may include, for each second communication device, a position relative to a reference point in the elevator shaft. For example, the lowest point of the elevator shaft may be the reference point, and the device map may have stored a distance of the device to the reference point, which in the example may be represented as a device height in the elevator shaft. Likewise, any other point in the elevator shaft, such as the highest point, the central point, or an arbitrary point, may be the reference point. The device map may allow the determination of a distance, a perceived distance or an approximate distance between the elevator car and a second communication device.

According to an aspect, the first communication device may include or consist of a wire-based communication device and the plurality of second communication devices may include or consist of second wire-based communication devices. Wire-based communication devices may be communication devices configured for exchanging data in a wire-based network, such as Ethernet and/or a network according to IEEE 802, such as a network according to IEEE 802.3.

According to an aspect, the first communication device may include or consist of a first wireless communication device and the plurality of second communication devices may include or consist of second wireless communication devices.

According to an aspect, in embodiments having a first wireless communication device positioned in or on the elevator car, and a plurality of second wireless communication devices, determining the car position indicator may include determining a signal strength indicator of a communication sent by the first wireless communication and received by the at least one of the plurality of second wireless communication devices. Additionally, or alternatively, determining the car position indicator may include determining a signal strength indicator of a communication sent by the at least one of the plurality of second wireless communication devices and received by the first wireless communication device. The car position indicator may be determined by a received signal strength indication (RSSI), including variations of an RSSI, such as a received channel power indicator (RCPI) or the like. Additionally, or alternatively, an angle of arrival (AoA) and/or an angle of departure (AoD) of a wireless signal, radio signal and/or communication may be utilized for determining the car position indicator. The AoA and/or the AoD may be a variation of an RSSI in the context of this disclosure.

A second wireless communication device may receive a transmission, such as a data packet, such as, for example, an SSID broadcast, and determine an RSSI of the transmission. Additionally, or alternatively, the first wireless communication device may receive a transmission, such as a data packet, such as, for example, a keepalive packet, and determine an RSSI of the transmission. The determined RSSI may be utilized by the first wireless communication device or the second wireless communication device directly, and/or be transmitted to further devices. For example, the first wireless communication device may receive a data packet from a second wireless communication device, and transmit the RSSI of the data packet sent from a second wireless communication devices to the second wireless communication device. The RSSI may be car position indicator, or the car position indicator may be derived from the RSSI, e.g. by performing mathematical operations thereon. Typically, a high RSSI corresponds to a low distance, thus, the car position indicator may be derived from the RSSI by calculating the inverse. The RSSI may be an arbitrary unit, or be expressed in e.g. mW, dBm any other unit. It is known that a signal strength obtainable by receiving a radio signal, i.e. an electromagnetic field, may not be directly proportional to a physical distance, but may be describable by near- or far-field effects and/or be approximated by, e.g. the inverse square law. Furthermore, effects such as shadowing or interference may affect the RSSI. Such effects and/or a non-linearity may occur and generally do not hinder determining a car position indicator indicative of a perceived distance, and thus the position of the elevator car relative to the second communication device.

The AoA/AOD may be utilized by a first wireless device and/or second wireless device configured for sending and/or receiving directional radio signals, particularly wireless signals. Determining the car position indicator may include determining an angle of arrival and/or an angle of departure of a communication between the first wireless communication device and received by the at least one of the plurality of second wireless communication devices. For example, the first wireless device and/or the second wireless device may include a directional antenna, such as a phased-array antenna, and be tunable for sending and/or receiving radio signals at defined angles. In embodiments where the first wireless device and one or more second wireless devices are provided essentially linearly along the elevator shaft, an AoA/AOD of essentially 0° (and/or 180°) along the direction of travel of the elevator car along the shaft may indicate a large distance, and an angle of essentially 90° relative to the direction of travel of the elevator car may indicate a close distance. According to embodiments, the car position indicator may be determined based on the AoA/AOD, for example by directly utilizing the AoA/AOD, and/or by performing a mathematical function such calculating a trigonometric function, such as a sine, cosine or tangent, based on AoA/AOD, or the like.

According to an aspect, in embodiments having a first wireless communication device positioned in or on the elevator car, and a plurality of second wireless communication devices, determining the car position indicator may include determining a perceived distance between the first communication device and the at least one of the plurality of second communication devices. The car position indicator may be determined by transmitting, e.g. broadcasting, a position indicator indicative of the position of the first wireless communication device, such as the position of the elevator car in the elevator shaft, to the plurality of second wireless communication devices. In the embodiment, the second wireless communication devices may have stored therein, e.g. in a memory, an identifier including a location indicator. The location indicator may be indicative of the position of the second wireless communication device relative to the elevator system, such as a floor number, a shaft position indicator indicating a distance from a reference point within the elevator shaft, or the like. The second wireless communication devices may receive the elevator car position, and calculate, from the location indicator and the position indicator, the car position indicator. In one simplified example, a second wireless communication device is installed on the 3rd landing of a building, and has this information stored as a location indicator. The elevator car currently is stationed at the 1st landing, and the first wireless communication device transmits a data packet including a position indicator indicative of the position “1st landing” to the second wireless communication device. The second wireless then derives, e.g. by subtracting the landing numbers, the car position indicator, which in the example would be 2 landings. Additionally, or alternatively, the first wireless communication device may have stored therein, e.g. in a memory, a dataset of the identifiers of the second wireless communication devices, the identifiers including a location indicator. The first wireless communication device may perform a calculation as described above for each second wireless communication device, and the car position indicator itself may be transmitted from the first wireless communication device to the second wireless communication device.

According to an aspect, further methods for determining the car position indicator may be suitable, particularly in embodiments having a first wireless communication device positioned in or on the elevator car, and a plurality of second wireless communication devices. Determining the car position indicator may include determining a response time of a response to a request sent by the first wireless communication device and received by at least one of the plurality of second wireless communication devices. The methods may include utilizing transmission times, e.g. by measuring a round trip time of a ICMP Echo-Request (“ping”). The method may combine methods according to embodiments described herein, e.g. several or all of the plurality of second wireless communication devices may pool their individually determined car position indicators, determine, e.g. by a consensus-based algorithm, a most likely current position of the first wireless communication device, and modify their individual car position indicator accordingly, e.g. a second wireless communication device may discard a car position indicator if it deviates from the consensus. The methods described herein may be implemented in any or all of the first wireless communication device, the plurality of second communication devices, or even a separate device, such as a central controller, network node, computer or server. The consensus may be calculated by the controller communicatively connected to the first and/or the plurality of second communication devices.

It was observed that in an elevator system according to this disclosure, the most relevant information between the first communication device and a second communication device occurs when the elevator car and the second communication device are in close proximity with each other, i.e. when the car position indicator indicates a short distance between the elevator car and the second communication device. For example, if a landing door control unit (second communication device) periodically transmits a status signal to the car control unit (first communication device), this signal is generally, at all times, relevant for evaluating the safety of the elevator system. Surprisingly, however, it was observed that most undesirable states of the elevator system due to bandwidth limitations, e.g. packet collision, delays or loss of packets, may be avoided by prioritizing the communication between physically close first and second wireless communication devices over physically distant first and second wireless communication devices. In the elevator system, this is generally the case for any type of first or second communication device, and particularly for first and second communication devices that show a higher data transmission rate when the elevator car and second communication devices are in close proximity, such as e.g. a car control unit and a landing door control unit that exchange more information when e.g. the synchronized opening of car and landing doors is performed than when the e.g. the safe closing and locking of a remote landing door is confirmed. Thus, a method for beneficially prioritizing such communication is described herein.

According to an aspect, a priority indicator for at least one of the plurality of second communication devices is determined. The priority indicator may be specific for each second communication device. A priority indicator may be determined for each of the plurality of second communication devices. The priority indicator is determined based on the car position indicator. A change of the car position indicator, e.g. due to a change of the elevator car position and/or the position-dependent communication condition, may typically result in a change of the priority indicator. Determining the priority indicator may include calculating, e.g. based on the elevator car position and the device map, a distance, such as a physical distance, an approximate distance and/or a perceived distance, between the elevator car and one, some or all of the plurality of second communication devices. The priority indicator may be a function of the distance of the elevator car to the second communication device. The priority indicator may increase with decreasing distance.

According to an aspect, in embodiments having a first wireless communication device positioned in or on the elevator car, and a plurality of second wireless communication devices, the priority indicator may be determined based on the car position indicator including the perceived distance between the first wireless communication device and the second wireless communication device. In such embodiments, determining an absolute position of the elevator car in the elevator shaft may not be required, and the car position indicator may include (only) information relating to the position of the first wireless communication device relative to at least one of the plurality of second wireless communication devices, such as information indicative of the perceived distance of the first wireless communication device to the second wireless communication device.

According to an aspect, a communication between the first communication device and the at least one of the plurality of second communication devices is prioritized based on the priority indicator. The prioritization may increase with e.g. a decreasing perceived distance as indicated by the priority indicator. A higher perceived distance may decrease the prioritization, and a lower perceived distance may increase the prioritization. The second communication device of the plurality of second communication devices with the lowest distance to the first wireless communication device may have the highest prioritization. The second communication device of the plurality of second communication devices with the highest distance to the first communication device may have the lowest prioritization.

According to an aspect, the priority indicator may be a binary value, e.g. the priority indicator may indicate either “prioritization” or “no prioritization”. The priority indicator may also be a continuous value and/or score, such as a score from 1 to 10 or from 0% to 100%. The upper and lower bounds of the score may be chosen arbitrarily. The priority indicator prioritization score may include a default value, i.e. devices that are considered low-priority may be assigned a default low priority indicator score, and devices that are considered high-priority may be assigned a default high priority indicator score. The default priority indicator may be adjusted for each of the second wireless communication devices, e.g. automatically or by a service technician during setup of the second wireless communication device. In a beneficial example, during prioritizing of a communication between the first communication device and at least one of the plurality of second communication devices, a high priority indicator score may allow a higher bandwidth for exchanging data, and a low priority indicator score may allow a lower bandwidth for exchanging data.

According to an aspect, prioritizing the communication between the first communication device and the at least one of the plurality of second communication devices may include increasing a transmission rate of the communication, e.g. based on a prioritization score. A second communication device may be configured for periodically communicating, e.g. sending a data packet, according to a predefined frequency. The frequency of sending the data packet may determine the transmission rate. The second communication device may be configured for transmitting at various rates, such as at least two, at least three, at least 5 or at least 10 different transmission rates, each transmission rate corresponding e.g. to a different data packet sending frequency. In one example, the second communication device may have a standard transmission rate and a prioritized transmission rate, the prioritized transmission rate being e.g. at least 2 times, at least 3 times, at least 5 times or at least 10 times higher than the standard transmission rate. Prioritizing the communication between the first communication device and the at least one of the plurality of second communication devices may include adjusting the transmission rate according to the priority indicator, i.e. a priority indicator indicating a low priority may result in a low transmission rate, and a priority indicator indicating a high priority may result in a high transmission rate. In one example, the transmission rate may correspond, or be defined by, a set interval at which status information, such as a door status, is sent from a second communication device to the first communication device. The interval may be set to a long interval, i.e. a low priority, if the car position indicator indicates a high distance, and the interval may be set to a short interval, i.e. a high priority, if the car position indicator indicates a low distance. By ensuing that only prioritized communications are transmitted at short intervals, the bandwidth of e.g. a wireless communication channel, or a wired connection communicatively connecting the first communication device and the plurality of second communication devices, may be freed and/or more efficiently utilized, resulting in less packet collisions and transmission delays.

According to an aspect, alternatively or additionally, the first communication device may be configured to selectively communicate with some or each of the plurality of second communication devices at different transmission rates, as described according to aspects or embodiments for the plurality of second communication devices. The first communication device, or a controller of the first communication device, may control the prioritization of the communication between the first communication device and the second communication devices. The first communication device may send requests, such as requests for status information, to some or each of the plurality of second communication devices at different transmission rates. The first communication device may set or control the transmission rate of the second wireless communication devices. For example, the first communication device may send periodic requests only to a selection of the plurality of second communication devices, and only second communication devices having received the request respond to the request. In a second example, the first communication device may broadcast such a request, and the request may include information, such as one or more destination addresses designating one or more second communication devices, and only the designated second communication devices may respond to the request.

According to an aspect, in embodiments having a first wireless communication device and a plurality of second wireless communication devices, prioritizing the communication between the first wireless communication device and the at least one of the plurality of second wireless communication devices may include increasing a transmission signal strength of the communication. A second wireless communication device may be configured for periodically communicating, e.g. sending a data packet, according to a predefined frequency. The second wireless communication device may be configured for transmitting at various transmission signal strengths, such as at least two, at least three, at least 5 or at least 10 different transmission signal strengths, each transmission signal strength corresponding e.g. to a different transmit power. In one example, the second wireless communication device may have a standard transmission signal strength and a prioritized transmission signal strength, the prioritized transmission signal strength being e.g. at least 2 times, at least 3 times, at least 5 times or at least 10 times higher than the standard transmission signal strength. Prioritizing the communication between the first wireless communication device and the at least one of the plurality of second wireless communication devices may include adjusting the transmission signal strength according to the distance car position, i.e. a car position indicator indicating a high distance may result in a low transmission signal strength, and a car position indicator indicating a low distance may result in a high transmission signal strength. In one example, the transmission signal strength may correspond, or be defined by, a set power at which status information, such as a door status, is sent from a second wireless communication device to the first wireless communication device. The power may be set to a low power, i.e. a low priority, if the car position indicator indicates a high distance, and the power may be set to a high power, i.e. a high priority, if the car position indicator indicates a low distance. By transmitting prioritized communications at a higher power, packet collisions may result in a prioritized data packet being received and a non-prioritized data packet being dropped. Thus, while the non-prioritized data packet may be delayed, the prioritized data packet will be transmitted as intended.

According to an aspect, in embodiments having a first wireless communication device and a plurality of second wireless communication devices, prioritizing the communication between the first wireless communication device and the at least one of the plurality of second wireless communication devices may include increasing a transmission bandwidth of the communication, e.g. based on a prioritization score. A second wireless communication device may be configured for periodically communicating, e.g. sending a data packet, according to a predefined frequency. The second wireless communication device may be configured for transmitting at various bandwidths, such as at least two, at least three, at least 5 or at least 10 different transmission bandwidths, each transmission bandwidth corresponding e.g. to a different prioritization score. In one example, the second wireless communication device may have a standard transmission bandwidth and a prioritized transmission bandwidth, the prioritized transmission bandwidth being e.g. at least 2 times, at least 3 times, at least 5 times or at least 10 times higher than the standard transmission bandwidth. Prioritizing the communication between the first wireless communication device and the at least one of the plurality of second wireless communication devices may include adjusting the transmission bandwidth according to the priority indicator, i.e. a priority indicator indicating a high distance may result in a low transmission bandwidth, and a priority indicator indicating a low distance may result in a high transmission bandwidth. In one example, the transmission bandwidth may be adjusted by choosing a data rate of a set of data rates, which may be defined by a wireless communication protocol. For example, if a protocol according to IEEE 802.11 is utilized, the protocol may allow different data rates for different modulation types, such as the 802.11g protocol allowing data rates of 6, 9, 12, 18, 24, 36, 48 and 54 Mbps. Accordingly, the prioritization score may be a score from 1 to 8, prioritization score 1 corresponding to 6 Mbps, prioritization score 2 corresponding to 9 Mbps, . . . , and prioritization score 8 corresponding to 54 Mbps. The same may be applied for any wireless communication protocol, particularly any wireless communication protocol according to IEEE 802.11, such as 802.11b/a/g/n/ac/ax or the like. The data rate may be set to a low data rate, i.e. a low priority, if the priority indicator indicates a high distance, and the data rate may be set to a high data rate, i.e. a high priority, if the priority indicator indicates a low distance. By ensuing that only prioritized communications are transmitted with a high-bandwidth modulation, the total bandwidth of e.g. a wireless communication channel may be more efficiently utilized, resulting in less packet collisions and transmission delays for prioritized communications.

According to an aspect, in embodiments having a first wireless communication device and a plurality of second wireless communication devices, alternatively or additionally, the first wireless communication device may be configured to communicate with some or each of the plurality of second wireless communication devices at different transmission bandwidths, as described according to aspects or embodiments for the plurality of second wireless communication devices. The first wireless communication device may control the second wireless communication devices, e.g. as an access point, and individually assign a to-be-used data rate to some or all of the plurality of second wireless communication devices.

According to an aspect, a direction indicator indicative of a movement direction of the elevator car relative to at least one of the plurality of second communication devices may be determined. The direction indicator may be derived from two or more car position indicator values determined at different timepoints. The direction indicator may be indicative of a relative movement direction of the elevator car and/or the first communication device in relation to a second communication device, or a set of second communication devices of the plurality of second communication devices. The direction indicator may be a binary value, e.g. representing the state “moving towards” or “moving away” from a second communication device. The direction indicator may further indicate no movement, i.e. no direction, e.g. in cases where the elevator car is stationary. The direction indicator may be derived from a physical movement of the elevator car, i.e. be directly related to the motion of the elevator car.

According to an aspect, the direction indicator may be indicative of the position-dependent communication condition. Particularly, the direction indicator may be an attribute of the car position indicator, i.e. depending on the position of a second communication device, the car position indicator may include information related to a distance between the elevator car and a second communication device, and may further include information related to the direction of the elevator car with respect to the second communication device, i.e. the elevator car may be moving towards or away from the position of the second communication device.

According to an aspect, based on the direction indictor, the priority indicator may be calculated, determined, modified, or adjusted. Additionally or alternatively, determining the priority indicator may be performed on the car position indicator in combination with the direction indicator. According to a beneficial example, the priority indicator may be calculated such that a second communication device that the elevator car is moving towards has a higher communication priority than a second communication device that the elevator car is moving away from. If the direction indicator indicates that the elevator car is moving towards the at least one of the plurality of second communication devices, the communication between the first communication device and the at least one of the plurality of second communication devices may be prioritized. If the direction indicator indicates that the elevator car is moving away from the at least one of the plurality of second communication devices, the communication between the first communication device and the at least one of the plurality of second communication devices may be de-prioritized. De-prioritization may include lowering a given priority, i.e. by reducing the value of a previously determined priority indicator, by setting the priority indicator to a low value such as zero, by setting a binary priority indicator to “false” or the like.

According to an aspect, the direction indicator does not necessarily have to strictly represent the physical direction of movement of the elevator car, e.g. an elevator controller may already determine a future direction of the elevator car, when the elevator car is still stationary, for example in cases where it is clearly determined that, following a stationary phase, the car will travel in a certain direction following the stationary phase, such as when the elevator car is still stationary with open doors, but will continue travelling in a defined direction once the doors have closed. Thus, a direction indicator may also be determined, at least in some cases, for a stationary elevator car. Accordingly, the direction indicator may be provided by a control module configured for controlling a movement of the elevator car and/or determining an elevator car position.

According to an aspect, the direction indicator may be determined from a series of car position indicator values, such as at least from two or more car position indicator values determined at different timepoints. A direction may be calculated by subtracting a first position from a second position and determining the sign of the result. Further methods for determining a direction indicator from a set of positions may be utilized.

According to an aspect, a first communication device and a second communication device are described. A communication device, i.e. a first and/or a second communication device, may be a device suitable for communicating with another device. The first communication device may be configured for communicating with a plurality of second communication devices. The second communication devices may be configured for communicating with the first communication device. The communication devices may be configured for communicating with further devices. For example, a second communication device may be configured for communicating with another at least one of the plurality of second communication devices. A communication device may include a communication module, such as a networking module, such as a modem, such as an Ethernet module, a WiFi module, a 2G, 3G, 4G, LTE, Bluetooth, 5G module or the like. A communication device may include a controller communicatively connected to the communication module. The controller may include a processor, such as microcontroller and/or a memory. The controller may be configured for executing instruction, sets of instructions, and/or programs, such as software programs, such as programs related to the operation of the elevator system. The controller may operate the communication module according to the aspects or embodiments described herein, particularly to communicatively connect the communication device in a packet-based network for exchanging data over the network. The communication device may be connected to sensors, actuators, displays, user input devices, sound modules, or yet further modules typically associated with an elevator system. The communication module may be a network interface for connecting the device to a data network, in particular a local data network, or, e.g. via a node, an access point, a router or the like, a global data network. The data network may be a TCP/IP network such as LAN, WAN, and/or Internet. The communication device may be operatively connected to the network module for carrying out commands received from the data network. The commands may include a control command for controlling the communication device to carry out a task such as reading sensor data, controlling a component of the elevator system, like a door actuator, operating a display for displaying information to a passenger or such. In this case, the communication device may be adapted for carrying out the task in response to the control command.

Reference will now be made in detail to the various embodiments, one or more examples of which are illustrated in the figures. Within the following description of the drawings, the same reference numbers refer to same components. Generally, only the differences with respect to individual embodiments are described. Each example is provided by way of explanation and is not meant as a limitation. Further, features illustrated or described as part of one embodiment can be used on or in conjunction with other embodiments to yield yet a further embodiment. It is intended that the description includes such modifications and variations.

### DESCRIPTION OF THE DRAWINGS

FIG. 1 shows a schematic elevator system according to an embodiment;

FIG. 2 shows a schematic elevator system according to another embodiment;

FIG. 3 shows a schematic elevator system according to a further embodiment;

FIG. 4 shows a communication device according to an embodiment; and

FIG. 5 shows a method of operating an elevator system according to an embodiment.

### DETAILED DESCRIPTION

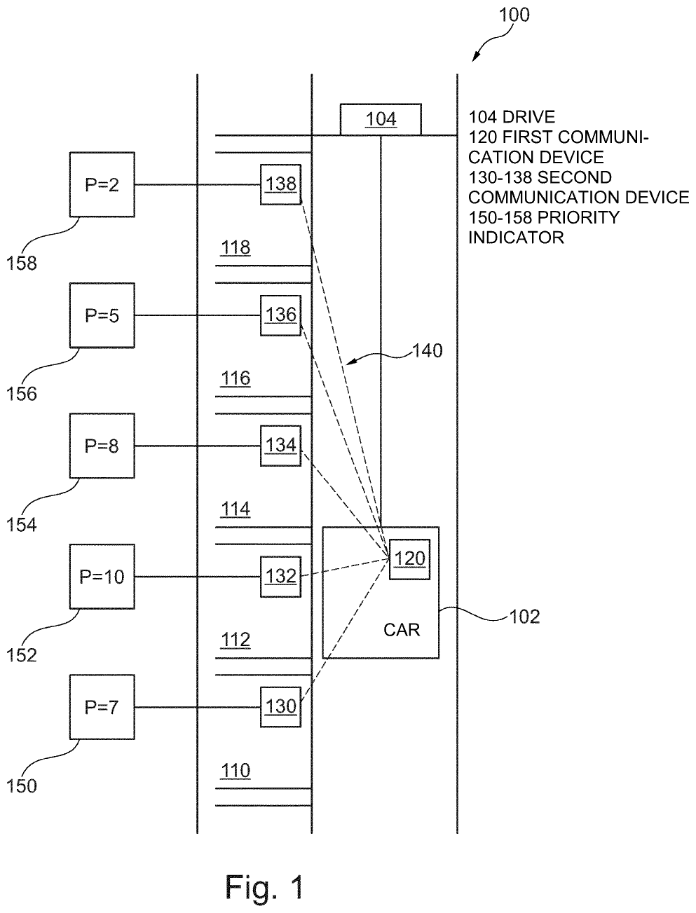

Referring now to FIG. 1, an elevator system 100 according to an embodiment is described. The elevator system 100 has an elevator car 102 provided in an elevator shaft. The elevator car 102 can be moved vertically by an elevator drive 104. In the embodiment, the elevator car is suspended on a cable, however, various other types of drive systems may be employed, and various other components of the elevator drive 104, such as rollers or counterweights were omitted in the drawing for clarity. The elevator system has five landings 110, 112, 114, 116 and 118, on different levels, e.g. within a building, which the elevator car 102 may travel to along the elevator shaft, e.g. for transporting passengers between the landings 110-118. The number of landings is exemplary and may be higher or lower. The benefits of the invention may become even more apparent in elevator systems with a large number of landings, e.g. a long elevator shaft. The elevator system 100 may have less than 5 landings, more than 5 landings, more than 7 landings, more than 10 landings or even more than 15 landings. Also, several landings on a floor might be possible.

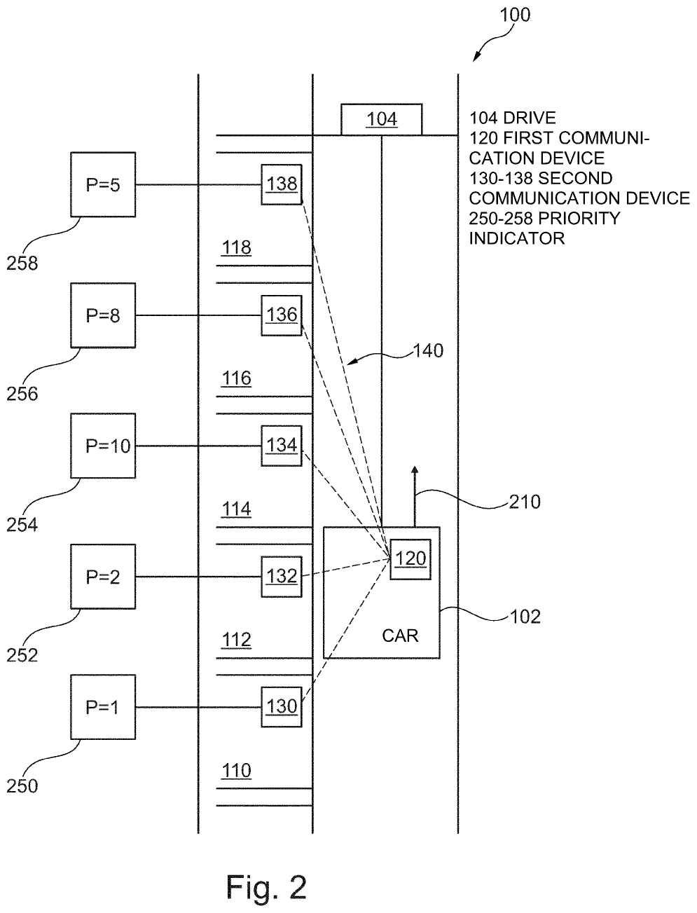

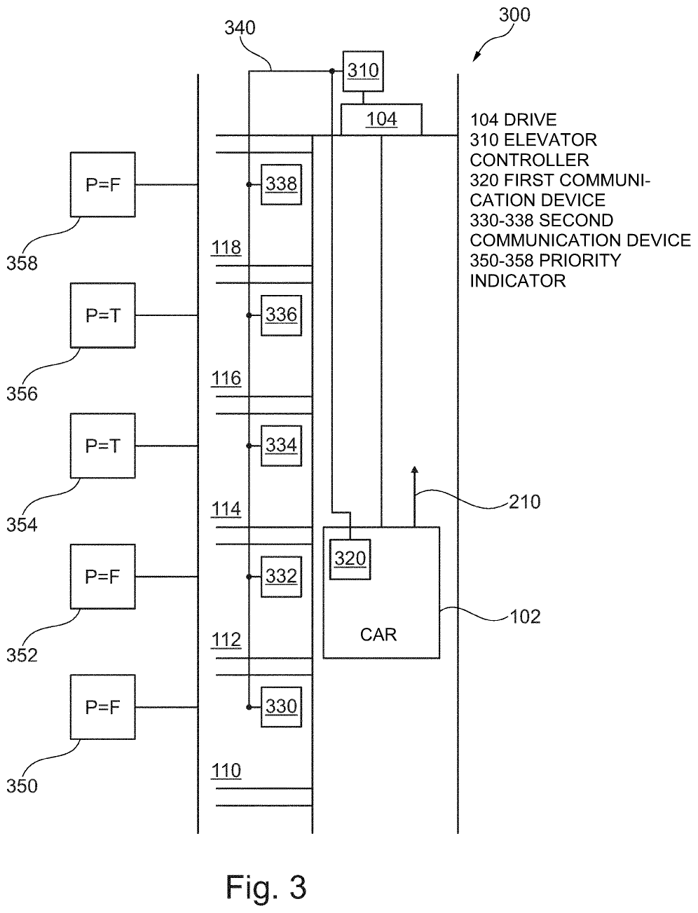

In the embodiments shown in FIG. 1 and FIG. 2, the first communication device is a first wireless communication device 120, and the second communication devices are second wireless communication devices 130, 132, 134, 136, 138. While some aspects of the embodiment are specific to the communication devices being wireless communication devices, other general aspects of the embodiment are not limited to the communication devices being wireless communication devices, and may be applied to embodiments having wired or wire-based communication devices, such as the embodiment shown in FIG. 3.

A first wireless communication device 120 is provided within the elevator car 102 and moves with the elevator car 102. The first wireless communication device 120 may also be provided at various locations within the elevator car or cabin, such as e.g. behind a panel within the elevator car 102 accessible from within the cabin. The first wireless communication device 120 may also be provided on the outside of the elevator car 102, e.g. on the roof of the elevator car 102. In other words, the first wireless communication device 120 is provided on the elevator car 102. In the embodiment, the first wireless communication device 120 moves together with the elevator car, thus, a car position indicator may be determined by determining a position of the first wireless communication device 120.

Each landing 110-118 has a second wireless communication device 130, 132, 134, 136, 138 provided at or near the landing. The second wireless communication devices 130-138 may also be provided inside the elevator shaft, inside a landing door, in a space between two landings or the like.

According to embodiments, the first wireless communication device 120 may be a control unit, such as a car control unit. Alternatively, the first wireless communication device 120 may be connected to the control unit. The control unit might be placed on the car or at a different location such as next to the drive or at every other location in the elevator system.

The control unit can control functions of the elevator system. The control unit can be communicatively connected with sensors and/or input devices, such as door sensors or landing operating panels, to receive input signals. The control unit can be communicatively connected with a number of second wireless communication devices, such as the second wireless communication devices 130-138. The second wireless communication devices 130-138 may be controllers, such as landing door controllers for controlling the opening or closing of the landing doors, sensors such as door sensors, landing operating panels, audiovisual displays or signaling devices such as bells or lanterns, or the like. The control unit can, e.g. based on user inputs received e.g. via the landing operating panels or a cabin operating panel, be configured to calculate a route of the elevator car and operate the elevator system to move the elevator car within the elevator shaft according to the calculated route. The control unit may be a car control unit and may include further or alternative functions than those described above.

The first wireless communication device 120 is communicatively connected with the second wireless communication devices 130-138 via a wireless connection. The wireless connection may be a wireless network, such as a network according to an IEEE 802.11 protocol. The first wireless communication device 120 may be configured as an access point of the wireless network. In the embodiment, the first wireless communication device 120 and the second wireless communication devices 130-138 are configured for sending and receiving data packets, the data packets including data such as sensor data, status data, instruction signals, control data, or the like.

As shown in FIG. 1, each second wireless communication device 130-138 has a distance 140 to the first wireless communication device 120, shown as dotted lines. The distance changes with the position of the elevator car 102 in the elevator shaft.

In the elevator system 100, the first wireless communication device 120 is configured for determining a car position indicator indicative of a perceived distance between the second wireless communication device 130-138 and the first wireless communication device 120. The car position indicator may be determined according to embodiments or aspects described herein, or according to a combination of embodiments or aspects described herein. The car position indicator may, additionally or alternatively, be determined by the second wireless communication device 130-138.

In the embodiment shown in FIG. 1, a priority indicator is calculated for each second wireless communication device 130-138 based on a signal strength of a radio transmission sent by the first wireless communication device 120 and received by the second wireless communication device 130-138. Additionally, or alternatively, a signal strength of a transmission sent by any one of the second wireless communication devices 130-138 and received by the first wireless communication device 120 may be utilized. In the embodiment, the signal strength serves as a car position indicator, since the signal strength is indicative of the position of the elevator car relative to the second communication devices.

The radio transmission may include a data packet, and/or may be a periodically sent transmission, such as an SSID broadcast. According to embodiments, only radio transmissions identified to have been sent by the first wireless communication device 120 or a known second wireless communication device 130-138 are utilized for determining the car position indicator. In the embodiment, the car position indicator corresponds to an RSSI of the radio transmission received by the second wireless communication device 130-138. The RSSI may range from e.g. −30 dBm for a strong signal, and −90 dBm for a very weak signal, however, alternative units, such as arbitrary units, may be used by the second wireless communication devices 130-138. If the RSSI is expressed in the unit dBm, a high dBm value typically corresponds with a low distance, e.g. a priority indicator may be, e.g. by a simple arithmetical function, derived directly from the RSSI, e.g. by multiplying the RSSI by −1.

/According to embodiments, the priority indicator may be determined for each received radio transmission, or periodically, e.g. at predetermined time intervals, such as approximately at least every 0.1, 0.2, 0.5, 1, 2, 5, or even 10 seconds.

After having determined the priority indicator, the communication between the first wireless communication device 120 and the at least one of the plurality of second wireless communication devices 130, 132, 134, 136, 138 is prioritized based on the priority indicator, such that the prioritization increases with a decreasing perceived distance as indicated by the priority indicator.

In the embodiment shown in FIG. 1, the prioritization, i.e. the priority indicator value P, is scaled on a scale from 1 to 10, with P=10 resulting in a high prioritization and P=1 resulting in a low prioritization. This scale is exemplary, and may be freely adjusted or adapted according to embodiments, e.g. according to the elevator system, the number of landings within the elevator system, the number of second wireless devices in the elevator system or the like.

According to embodiments, instead of utilizing a scale, the second wireless communication devices may be configured to include two prioritization modes, with one mode corresponding to a standard priority and another mode corresponding to a high priority. The high priority mode may be entered when the priority indicator indicates a (perceived) distance below a threshold, such as a predefined threshold.

According to embodiments, the elevator system may automatically tune, e.g. during a set-up procedure, or continuously during the operation of the elevator system, the prioritization scale and/or threshold according to a number of priority indicators observed over time. In a typical elevator system, the elevator car 102 will pass each second wireless communication device 130-138 several times during operation, resulting in a lowest perceived distance to the first wireless communication device 120 as indicated by the car position indicator and/or priority indicator derived thereof. This car position indicator corresponding to the lowest perceived distance may be assigned the highest priority on the priority scale. Likewise, the elevator car 102 may reach a point in the elevator shaft that is furthest away and/or shows the highest perceived distance, thus, for the car position indicator corresponding to the highest perceived distance may be assigned the lowest priority on the priority scale. A threshold may be set according to the observed minimum and maximum distance indicators, e.g. a high priority mode may be entered when the priority indicator indicates a perceived distance within the lowest 5% of the range between the minimum and maximum observed distance indicator, or below 10%, below 15% or even below 20%.

In the embodiment shown in FIG. 1, the priority indicator value P 150, 152, 154, 156, 158 is shown for each second wireless communication device 130-138. The priority indicator value P corresponds to the perceived distance of each second wireless communication device 130-138 to the first wireless communication device 120, the perceived distance corresponding to the distance 140. As shown in FIG. 1, the elevator car 102 is adjacent to the landing 112, thus the physically closest second wireless communication device 132 has the shortest perceived distance and the highest priority indicator value 152 (P=10). As shown in FIG. 1, the elevator car 102 is three landings below the landing 118, thus the physically most distant second wireless communication device 138 has the longest perceived distance and the lowest priority indicator value 158 (P=1). The priority indicator values 150, 154, 156 for the remaining second wireless communication devices 130, 134, 136 are shown in FIG. 1.

While FIG. 1 shows only a single state of the elevator system 100, it is clear that the priority indicator values 150-158 change with the location of the first wireless communication device 120, e.g. if the elevator car 102 is adjacent to landing 118, the priority indicator value 158 is P=10, the priority indicator value 156 is P=7, the priority indicator value 154 is P=5, the priority indicator value 152 is P=3 and the priority indicator value 150 is P=1. If the elevator car 102 is adjacent to landing 110, the priority indicator value 158 is P=1, the priority indicator value 156 is P=2, the priority indicator value 154 is P=5, the priority indicator value 152 is P=8 and the priority indicator value 150 is P=10.

In the embodiment shown in FIG. 1, the communication between the first wireless communication device 120 and the second wireless communication devices 130-138 is prioritized by increasing the frequency at which data packets are exchanged between the wireless communication devices, i.e. the number of data packets transmitted or transmittable per time unit.

In a first example, a low-priority second wireless communication device may communicate less often per time frame than a high-priority second wireless communication device. For example, a second wireless communication device having a priority indicator value of 1 may communicate once per second, and a second wireless communication device having a priority indicator value of 10 may communicate ten times per second.

In a second example, the first wireless communication device 120 periodically sends request packets as a broadcast. The broadcast includes identifiers of a subset of the second wireless communication devices 130-138. Only the identifiers of second wireless communication devices for which the priority indicator value exceeds a threshold are included in the broadcast. Only second wireless communication devices being identified by the identifier will respond to the request. For example, the identifier may be a MAC address of the second wireless communication device. For example, the threshold, in the example shown in FIG. 1, may be chosen as e.g. 6, so that only the second wireless communication devices 130, 132, and 134 respond to the request. Thus, the bandwidth required for responding to the request is reduced from that required by five second wireless communication devices to that required by three second wireless communication devices. This may beneficially reduce the likelihood of packet collisions or transmission delays, even when the overall bandwidth of the communication is limited.

Referring now to FIG. 2, a second implementation of the elevator system 100 according to an embodiment is shown. Only the differences between the elevator system 100 shown in FIG. 1 and the elevator system 100 shown in FIG. 2 are explained in detail. In addition to being indicative of a position of the elevator car, the car position indicator is indicative of a position-dependent communication condition by also including information about the movement direction 210 of the elevator car 102. In the example shown in FIG. 2, the elevator car is in motion and moving upwards. The perceived distances 140 are identical to those shown in FIG. 1; additionally, based on the perceived distances over time, a perceived direction of movement is determined, e.g. by simple subtraction of two or more perceived distances.

In the example, the priority indicator is determined on the car position indicator, i.e. both the position and the direction of movement of the elevator car 102 are considered. This results in lower priority indicator scores 250, 252 for the second wireless communication devices 130, 132 located on landings which the elevator car 102 is moving away from, and a higher priority indicator scores 254-258 for devices which the elevator car 102 is moving towards. In the given example, the priority indicator scores are increased by +3 up to a maximum value of 10 when the elevator car moves towards the second wireless communication device, such as second wireless communication devices 134-138, and significantly reduced and limited to a maximum value of 2 when the elevator car moves away from the second wireless communication device, such as second wireless communication devices 130, 132. The increase and/or reduction of the priority indicator score based on the direction indicator may be adjusted according to each individual elevator installation, and is not limited to the example given herein.

Referring now to FIG. 3, an elevator system 300 according to an embodiment is shown. Only differences to the elevator system 100 shall be explained in detail. The elevator system 300 has a first communication device 320 and a plurality of second communication devices 330, 332, 334, 336, 338. The first communication device 320 and the second communication devices 330-338 are connected with a wired connection 340 in a network, shown in a bus-like configuration. Other types of configurations or topologies may be equally suitable. Furthermore, an elevator controller 310 is connected to the network. The elevator controller controls the movement of the elevator car 102 in the elevator system 300. The elevator controller 310 may be a control module for controlling a movement of the elevator car and/or determining an elevator car position. The elevator controller 310 is an optional component and shown in the exemplary embodiment to help with understanding the invention. In some embodiments, the elevator controller 310 or functions of the elevator controller 310 described herein may be included in e.g. the first communication device 320, or the elevator controller 310 may be a second communication device.

In the embodiment shown in FIG. 3, the elevator car 102 is stationary and about to depart from the landing 112 in the upwards direction. The elevator controller 310 is aware of the position of the elevator car 102 in the elevator shaft. Furthermore, the elevator controller 310 is aware of the planned route of the elevator car 102, which, in the embodiment shown in FIG. 3, is upwards. The elevator controller 310 transmits the position information and the planned route to the first communication device 320 and/or the second communication devices 330-338. The first communication device 320 determines a car position indicator from the position of the elevator car and the planned route, and determines a priority indicator 350, 352, 354, 356, 358 for each of the second communication devices 330-338 based on a device map stored in a memory of the first communication device 320, by determining an approximate distance to each of the second communication devices and whether the planned route will lead towards or away from the second communication device 330-338.

In the embodiment, the priority indicator 350-358 is a binary value, and the priority indicator is set to indicate an intended prioritization for the closest two levels that the elevator car will reach according to the planned route. Thus, the communication is prioritized for the second communication devices 334, 336, and non-prioritized for the second communication devices 330, 332, 338. Accordingly, the priority indicator 350, 352, 358 are “false” (“F”) and the priority indicator values 354, 356 are “true” (“T”). If, for example, the elevator car reaches landing 114 and continues traveling upwards, the priority indicator 354 may switch to “false” and the priority indicator 358 may switch to “true”.

According to embodiments, the functions described for the elevator controller 310 may be implemented in the first communication device 320. According to embodiments, the first communication device 320 may be located at any position and is not limited to being provided inside the elevator car 102, as shown in FIG. 3.

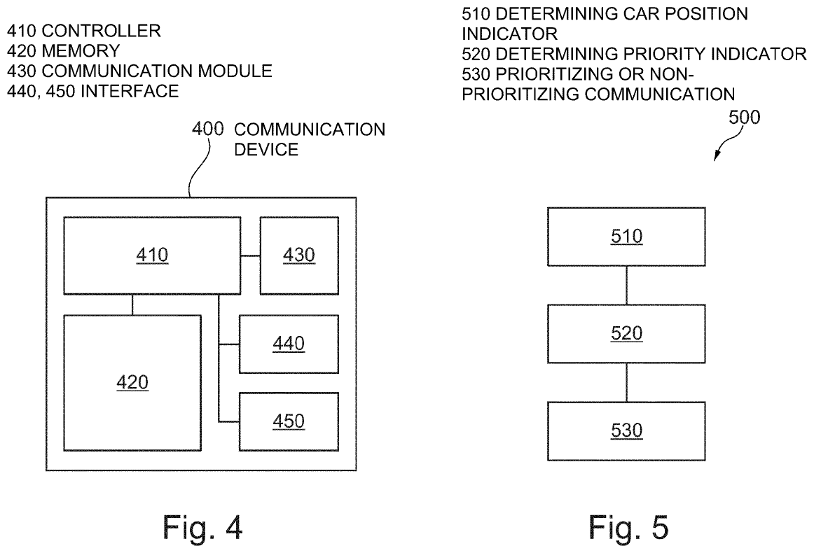

Referring now to FIG. 4, a communication device 400 is shown. The communication device 400 may be a first communication device or a second communication device according to aspects and/or embodiments described herein. The communication device 400 may be configured for executing a method according to aspects and/or embodiments described herein. The communication device 400 has a controller 410. The controller may include a processor, a CPU, a microcontroller or the like. The controller 410 may be configured for executing a set of instructions such as a program or a software. The software may be stored in a memory 420. The memory 420 may further store additional information, such as a device map according to aspects or embodiments described herein. The memory 420 may be, at least in part, transient. The memory 420 may be, at least in part, persistent. The memory may include a RAM and a ROM portion. The controller 410 may access the memory 420 to retrieve data from the memory 420, and store data in the memory 420. The communication device 400 has a communication module 430. The communication module 430 may be configured for communicatively connecting the communication device to further communication devices, according to aspects and/or embodiments described herein. The controller 410 may be configured for operating the communication module 430 for sending and receiving data to/from the further communication device. The controller 410 may be configured for operating the communication module 430 to prioritize or not prioritize a communication between the communication device 400 and a further communication device communicatively connected to the communication device according to aspects and/or embodiments described herein. The communication device may include one or more interfaces 440, 450 for interfacing with components of an elevator system, such as the elevator system 100, 300. The interfaces 440, 450 may, for example, be configured for connecting the communication device 400 to sensors, actuators, user interfaces or the like. The controller 410 may be configured for operating the interfaces 440, 450 to control functions or aspects of the elevator system, such as opening and closing doors, according to aspects and/or embodiments described herein.

Referring now to FIG. 5, a method 500 of operating an elevator system is described. The method 500 may be a method according to aspects and/or embodiments described herein. The method may be executed by a communication device or a plurality of communication devices according to aspects and/or embodiments described herein, such as the communication device 400. The method includes determining 510 a car position indicator. The method includes determining 520 a priority indicator based on the car position indicator. The method includes prioritizing or non-prioritizing 530 a communication between a first communication device and a second communication device.

According to embodiments, the use of a first communication device and at least one of a plurality of second communication devices in an elevator system is described. The elevator system may be an elevator system according to aspects and/or embodiments described herein. The devices may be operated according to aspects and/or embodiments of a method described herein.

According to embodiments, a computer program comprising instructions to cause a communication device in an elevator system to execute the operations of a method according to an aspect and/or embodiment described herein is described. The computer program may, for example, be stored in a memory of the first and/or second communication device, such as the memory 420.

According to embodiments, a computer-readable medium having stored thereon a computer program comprising instructions to cause a communication device in an elevator system to execute the operations of a method according to an aspect and/or embodiment described herein is described. The computer-readable medium may be a known storage device. The computer-readable medium may be a storage device included in a computer system communicatively connected to the communication device. The computer system may be a software delivery system, such as an update system, configured for enabling the communication device to retrieve the computer program.

Benefits of the described invention and embodiments thereof allow a more efficient use of the available bandwidth within a control network controlling an elevator system. According to embodiments, the communication between a control unit, such as the first communication device, and a number of second communication devices, such as controllers controlling landing-specific functions, is prioritized according to predefined rules, the prioritization generally being dependent on the elevator car position and/or a position-dependent communication condition. Thus, in cases where the communication bandwidth is limited, safety-relevant information may be transmitted more reliably from those devices that are more critical for the safe and efficient operation of the elevator system at a given time, without having to limit the transmission rate of any particular device.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method of operating an elevator system, the elevator system including an elevator car, a first communication device movable with the elevator car, and a plurality of stationary second communication devices communicatively connected to the first communication device, the method comprising the steps of:
determining a car position indicator being indicative of a position of the elevator car and/or a position-dependent communication condition of the elevator car relative to at least one of the second communication devices;
determining, based on the car position indicator, a priority indicator for each of the second communication devices; and
prioritizing or non-prioritizing, based on the priority indicator for the at least one second communication device, a communication between the first communication device and the second communication device.

17. The method according to claim 16 wherein the first communication device and the second communication devices are communicatively connected via a packet-based communication network.

18. The method according to claim 16 wherein determining the car position indicator includes determining a perceived distance between the first communication device and the at least one second communication device.

19. The method according to claim 16 wherein the priority indicators are a binary value or a continuous value, and wherein each of the priority indicators is a function of the perceived distance between and/or a relative movement direction of the first communication device and an associated one of the second communication devices.

20. The method according to claim 16 wherein the first communication device and the second communication devices are communicatively connected via a wireless communication network, and wherein the first communication device is a first wireless communication device and the second communication devices are each a second wireless communication device.

21. The method according to claim 20 wherein determining the car position indicator includes at least one of:
determining a signal strength indicator of a communication sent by the at least one second wireless communication device and received by the first wireless communication device;
determining a signal strength indicator of a communication sent by the first wireless communication device and received by the at least one second wireless communication device;
determining a response time of a response to a request sent by the first wireless communication device and received by the at least one second wireless communication device;
determining an angle of arrival and/or an angle of departure of a communication between the first wireless communication device and the at least one second wireless communication device; and
receiving an elevator car position from a control module configured for at least one of controlling a movement of the elevator car and determining the position of the elevator car.

22. The method according to claim 16 including determining a direction indicator indicative of a movement direction of the elevator car relative to the at least one second communication device, the direction indicator being indicative of the position-dependent communication condition.

23. The method according to claim 22 including:
when the direction indicator indicates that the elevator car is moving towards the at least one second communication device, prioritizing the communication between the first communication device and the at least one second communication device; and/or
when the direction indicator indicates that the elevator car is moving away from the at least one second communication device, de-prioritizing the communication between the first communication device and the at least one second communication device.

24. The method according to claim 22 including deriving the direction indicator from two or more values of the car position indicator determined at different timepoints.

25. The method according to claim 22 including providing the direction indicator by a control module configured for controlling a movement of the elevator car.

26. The method according to claim 18 including prioritizing the communication between the first communication device and the at least one second communication device by increasing a transmission rate of the communication.

27. A computer program product comprising computer instructions stored on a non-transitory medium, the computer instructions when executed by a communication device in an elevator system cause the communication device to operate and perform the method according to claim 16.

28. A non-transitory computer-readable medium having stored thereon the computer program product according to claim 27.

29. An elevator system comprising:
an elevator car;
a first communication device that is movable with the elevator car;
a plurality of stationary second communication devices communicatively connected to the first communication device;
wherein the first communication device is configured for determining, based on a position of the elevator car and/or a position-dependent communication condition, a car position indicator, the car position indicator being indicative of a position of the elevator car relative to at least one of the second communication devices;
wherein the first communication device is configured for determining, based on the car position indicator, a priority indicator for each of the second communication devices; and
wherein the first communication device is configured for, based on the priority indicator for the at least one second communication device, prioritizing or non-prioritizing the communication between the first communication device and the at least one second communication device.
